(19) United States
(12) Patent Application Publication
(10) Pub. No.: US 2022/0128090 A1
(43) Pub. Date: Apr. 28, 2022

(54) BEARING DEVICE, MOTOR AND FAN MOTOR HAVING THE SAME

(71) Applicant: NEDEC Co., Ltd., Gimcheon-si (KR)

(72) Inventors: Ho Kyung JANG, Suwon-si (KR); Yong Sik KIM, Suwon-si (KR)

(73) Assignee: NEDEC Co., Ltd., Gimcheon-si (KR)

(21) Appl. No.: 17/493,866

(22) Filed: Oct. 5, 2021

(30) Foreign Application Priority Data
Oct. 27, 2020 (KR) 10-2020-0140047

(51) Int. Cl. F16C 33/10; F16C 35/02; F04D 29/056; F04D 25/06

(52) U.S. Cl. CPC F16C 33/107; F16C 33/103; F16C 2360/46; F04D 29/056; F04D 25/062; F16C 35/02

(57) ABSTRACT

According to the present invention, foreign substances, such as external dust and the like, can be prevented from being introduced into a lubricating fluid inside a bearing, so that the extension of the durability life of a motor or fan motor can be expected and once the assembly of a rotor assembly is completed, an impeller and a stator assembly can be assembled even in a non-clean room environment, thereby reducing cost and time in an assembly process, and because a sealing protrusion can block external foreign substances in a state in which the sealing protrusion is located radially inside a sleeve than the outer diameter of the sleeve, the design of a stator core can be made more freely, and it can be applied in even a case where the inner diameter of the stator core is small and the thickness of the stator core is large.

### CROSS-REFERENCE TO RELATED PATENT APPLICATIONS

This application claims the benefit of Korean Patent Application No. 10-2020-0140047, filed on Oct. 27, 2020, in the Korean Intellectual Property Office, the disclosure of which is incorporated herein in its entirety by reference.

### BACKGROUND OF THE INVENTION

### 1. Field of the Invention

The present invention relates to a bearing device, a motor and a blower motor having the same, and more particularly, to a bearing device configured to prevent foreign substances such as dust and the like from being introduced into a lubricating fluid used in a fluid dynamic bearing, and a motor and a blower motor having the same.

### 2. Description of the Related Art

According to the recent high density of electronic devices, generally, a blower fan for cooling electronic components is arranged around the electronic components mounted on the electronic devices. The blower fan is a device in which a rotating body, that is, an impeller rotates to generate an air flow, and due to an increase in the amount of heat generated by the high density of the electronic devices, the blower fan also requires high-performance specifications such as high-speed rotation.

However, when the blower fan rotates at a high speed, the peak value of vibration at each frequency rises, which has a problem of adversely affecting the electronic components. Recently, as the demand for low current, shock resistance, and vibration resistance increases in ultra-slim laptops, a fluid dynamic bearing assembly is used for a spindle motor of the blower fan, and oil is placed between the shaft and the sleeve of the fluid dynamic bearing assembly, and due to a fluid pressure generated in the oil, a structure such as supporting the shaft is adopted, but malfunction may occur when foreign substances such as dust and the like are introduced into the fluid dynamic bearing under abnormal conditions.

### SUMMARY OF THE INVENTION

The present invention provides a bearing device that is capable of preventing foreign substances such as dust and the like from entering a lubricating fluid inside a fluid dynamic bearing, a motor and a blower fan having the same.

According to an aspect of the present invention, there is provided a bearing device including: a holder including a base plate extending in a horizontal direction and a shaft coupling tube having a tube structure extending upward from a center of the base plate; a shaft rotatably fitted to the shaft coupling tube; a bearing module inserted between the shaft and the shaft coupling tube to rotatably support the shaft from the shaft coupling tube; a housing fitted to or integrated with a lower portion of the shaft coupling tube to support the shaft in an axial direction; and a hub coupled to the shaft to rotate together with the shaft and extending in a radial direction of the shaft to cover an upper portion of the shaft coupling tube into which the shaft is fitted, wherein the bearing module includes: a sleeve that is inserted into the shaft in a state in which a gap between the sleeve and the shaft is filled with a lubricating fluid, and disposed between the shaft and the shaft coupling tube, thereby rotatably supporting an outer circumferential surface of the shaft from an inner circumferential surface of the shaft coupling tube, the sleeve including a sealing accommodating groove formed at an upper surface of the sleeve and having a retracted structure extending along a circumferential direction; and a thrust bearing disposed between the sleeve and the housing to axially support a lower portion of the sleeve from the housing, and the hub includes: a sleeve upper cover body protruding from a lower surface of the hub and facing an upper portion of the shaft coupling tube to cover an upper portion of the sleeve; and a sealing protrusion protruding from the sleeve upper cover body and fitted into the sealing accommodating groove, thereby covering a gap formed between the sleeve upper cover body and the upper surface of the sleeve to prevent foreign substances from entering through the gap from an outside of the shaft coupling tube.

According to another aspect of the present invention, there is provided a motor including: the bearing device described above; a stator fitted to an outside of the shaft coupling tube and fixed to the holder, the stator including a plurality of cores disposed on an outer edge of the holder; and a rotor that is coupled to the hub and disposed to surround the stator and includes a plurality of magnets disposed to correspond to the cores on an inner circumferential surface facing an outer edge of the stator, and the rotor rotating along the outer edge of the stator by using a rotating magnetic field formed by the cores and the magnets by an alternating current applied to the cores, so that a rotational force is provided to the shaft.

According to another aspect of the present invention, there is provided a fan motor including: a holder including a base plate extending in a horizontal direction and a shaft coupling tube having a tube structure extending upward from a center of the base plate; a shaft rotatably fitted to the shaft coupling tube; a bearing module inserted between the shaft and the shaft coupling tube to rotatably support the shaft from the shaft coupling tube; a housing fitted to or integrated with a lower portion of the shaft coupling tube to support the shaft in an axial direction; and a hub coupled to the shaft to rotate together with the shaft and extending in a radial direction of the shaft to cover an upper portion of the shaft coupling tube into which the shaft is fitted, wherein the bearing module includes: a sleeve that is inserted into the shaft in a state in which a gap between the sleeve and the shaft is filled with a lubricating fluid, and disposed between the shaft and the shaft coupling tube, thereby rotatably supporting an outer circumferential surface of the shaft from an inner circumferential surface of the shaft coupling tube, the sleeve including a sealing accommodating groove formed at an upper surface of the sleeve and having a retracted structure extending along a circumferential direction; and a thrust bearing disposed between the sleeve and the housing to axially support a lower portion of the sleeve from the housing, and the hub includes: a sleeve upper cover body protruding from a lower surface of the hub and facing an upper portion of the shaft coupling tube to cover an upper portion of the sleeve; a sealing protrusion protruding from the sleeve upper cover body and fitted into the sealing accommodating groove, thereby covering a gap formed between the sleeve upper cover body and the upper surface of the sleeve to prevent foreign substances from entering through the gap from an outside of the shaft coupling tube; a stator fitted to an outside of the shaft coupling tube and fixed to the holder, the stator including a plurality of cores disposed on an outer edge of the holder; a rotor that is coupled to the hub and disposed to surround the stator and includes a plurality of magnets disposed to correspond to the cores on an inner circumferential surface facing an outer edge of the stator, and the rotor rotating along the outer edge of the stator by using a rotating magnetic field formed by the cores and the magnets by an alternating current applied to the cores, so that a rotational force is provided to the shaft; and an impeller coupled to the hub or the shaft and rotating so as to generate a flow of air.

According to the present invention, there are the following effects.

First, foreign substances, such as external dust and the like, can be prevented from being introduced into a lubricating fluid inside a fluid dynamic bearing, so that the durability of a motor or fan motor can be extended.

Second, contamination of bearings during assembly handling can be prevented, and once the assembly of a rotor assembly is completed, an impeller and a stator assembly can be assembled even in a non-clean room environment, thereby reducing cost and time in an assembly process.

Third, since a sealing protrusion can block external foreign substances in a state in which the sealing protrusion is located radially inside a sleeve than the outer diameter of the sleeve, the design of a stator core can be made more freely, and it can be applied in even a case where the inner diameter of the stator core is small and the thickness of the stator core is large.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a fan motor provided with a bearing device according to an embodiment of the present invention;

FIG. 2 is a front cross-sectional view showing a coupling relationship of the fan motor shown in FIG. 1;

FIG. 3 is an exploded perspective view showing a detail configuration of the fan motor shown in FIG. 1;

FIG. 4 is an enlarged view showing essential parts showing a coupling relationship between a hub and a shaft coupling tube for describing a configuration for blocking dust inflow by using a sealing protrusion in the bearing device shown in FIG. 2; and

FIG. 5 is a cross-sectional view of essential parts for describing a dynamic pressure groove in a radial direction and a dynamic pressure groove in a thrust direction in the bearing device shown in FIG. 2.

### DETAILED DESCRIPTION OF THE INVENTION

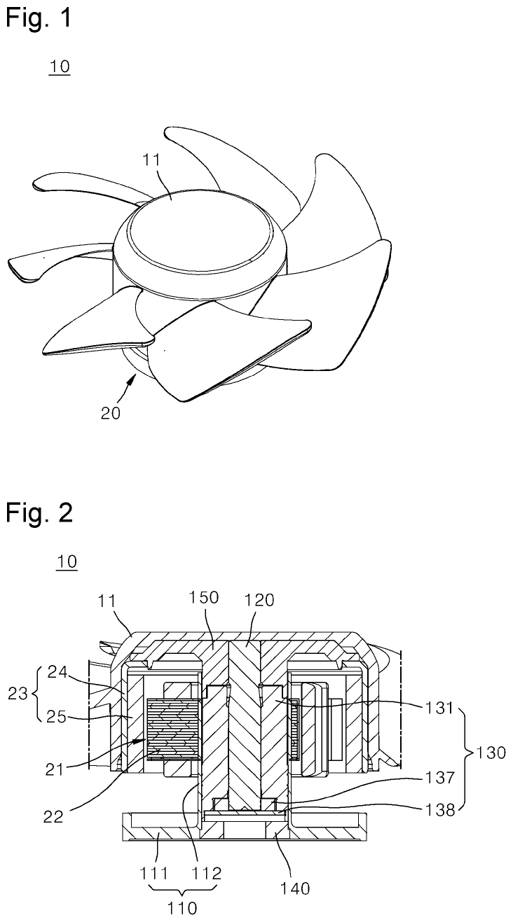

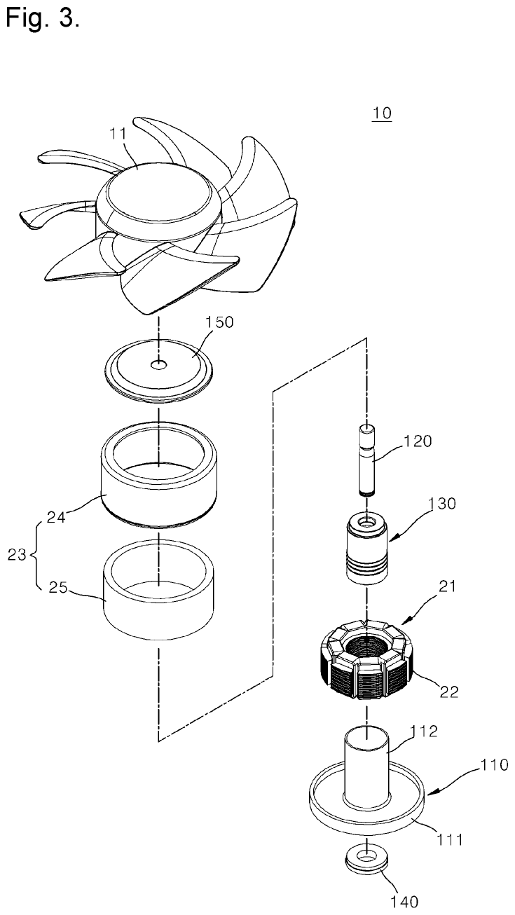

FIGS. 1 through 3 show the configuration of a fan motor 10 according to an embodiment of the present invention. Referring to FIGS. 1 through 3, the fan motor 10 according to an embodiment of the present invention is driven while preventing foreign substances such as dust from entering a lubricating fluid LF filled in a fluid dynamic bearing device 100 provided as a fluid dynamic bearing, and the fan motor 10 includes an impeller 11 and a motor 20.

The impeller 11 is coupled to a hub 150 or shaft 120 to be described later and rotates in the upper portion of the motor 20, thereby generating the flow of air to cool a desired electronic device or heating element.

The motor 20 is for providing a rotational driving force to the above-described impeller 11, and includes a stator 21, a rotor 23, and the bearing device 100. The stator 21 is fitted on the outside of a shaft coupling tube 112 of the bearing device 100 to be described later and is fixed to a holder 110, and includes a plurality of cores 22 including wound coils disposed on the outer edge of the holder 110.

The rotor 23 is coupled to the hub 150 of the bearing device 100 to be described later and is disposed to surround the stator 21, and includes a plurality of magnets 25 disposed to correspond to the cores 22 on an inner circumferential surface facing the outer edge of the stator 21, that is, the inner circumferential surface of a yoke 24. When an alternating current is applied to the wound coil of the above-described stator 21, the rotor 23 rotates along the outer edge of the stator 21 by using a rotating magnetic field formed by the cores 22, so that a rotational force for rotating the impeller 11 is provided to the shaft 120 provided in the bearing device 100. Known technical configurations can be applied to the basic configuration of the motor 20 described above, and a detailed description thereof will be omitted.

The bearing device 100 supports the shaft 120 installed in the motor 20 described above in a state in which wear and loss of the rotating shaft 120 provided in the motor 20 is greatly reduced, and the bearing device 100 has a fluid dynamic bearing structure, and includes the holder 110, a shaft 120, a bearing module 130, a housing 140, and a hub 150.

The holder 110 corresponds to a base of the motor 20, is provided under the motor 20, is formed in a disk shape, and includes a base plate 111 that extends along a radial (horizontal) direction, and the shaft coupling tube 112 having a tube structure and extending along a direction transverse to a radial direction from the center of the base plate 111, that is, a vertical direction. At this time, a plurality of exhaust ports (not shown) capable of discharging heated air by the heat dissipation of the cores 22 may be formed in the holder 110 after the flow of air generated through the impeller 11 is provided to the cores 22 of the stator 21 described above through the hub 150 so as to cool the cores 22.

The shaft 120 is formed in a cylindrical shape and rotates by the rotation of the rotor 23 in a state rotatably fitted to the shaft coupling tube 112 of the holder 110 to transmit the rotational driving force to the impeller 11.

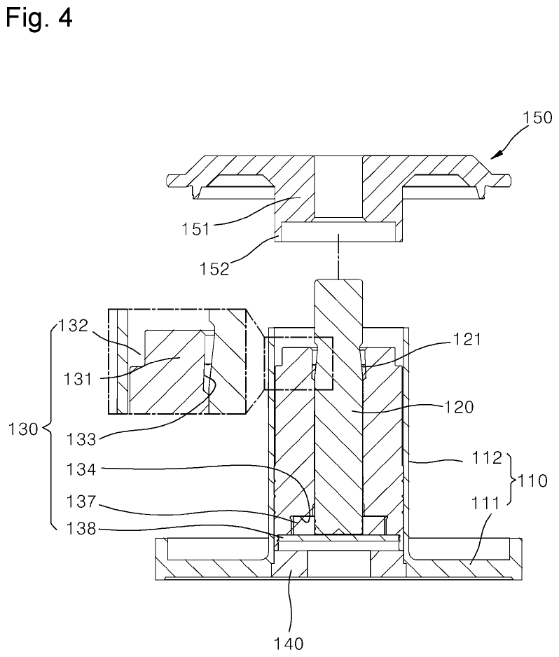

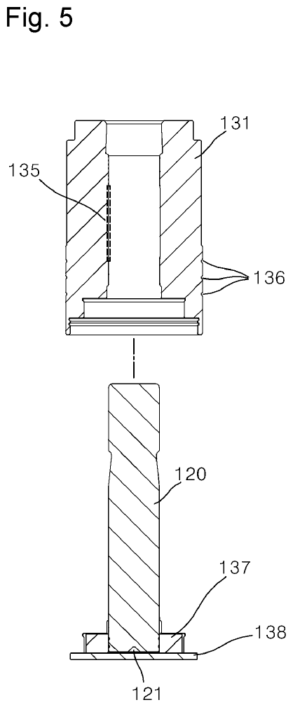

The bearing module 130 is for supporting the outer circumferential surface of the shaft 120 from the inner circumferential surface of the shaft coupling tube 112, and includes a sleeve 131, a thrust bearing 137, and a sleeve lower cover body 138. The sleeve 131 is inserted into the shaft 120 in a state in which the lubricating fluid LF is filled in a gap with the shaft 120 to be disposed between the shaft 120 and the shaft coupling tub 112, to rotatably support the outer circumferential surface of the shaft coupling tube 112 from the inner circumferential surface of the shaft coupling tube 112. Here, the detailed configuration of the sleeve 131 and functions thereof will be described in detail again with reference to FIGS. 4 and 5 to be described later.

The thrust bearing 137 is fitted to the shaft 120 under the sleeve 131 to support the axial load of the shaft 120. The sleeve lower cover body 138 is installed (bonded) on the upper portion of the housing 140 to be described later and simultaneously supports the lower portion of the sleeve 131, the lower portion of the thrust bearing 137, and the lower portion of the shaft 120, thereby preventing the shaft 120 from flowing in the axial direction and blocking the lower leakage of the lubricating fluid LF filled between the shaft 120 and the sleeve 131 and the thrust bearing 137.

The housing 140 is fitted to the lower portion of the shaft coupling tube 112 to close the lower portion of the shaft coupling tube 112, and supports the sleeve lower cover body 138 described above.

The hub 150 is formed to extend in the radial direction in a state coupled (bonded) to the upper portion of the shaft 120 to transmit the rotational force of the rotor 23 to the shaft 120 as well as to cover and close the upper portion of the shaft coupling tube 112, so that the gap between the shaft 120 and the sleeve 131 is covered to prevent foreign substances such as dust from entering between the shaft 120 and the sleeve 131. In addition, as an exhaust port is formed in the base plate 111 of the holder 110, an inlet (not shown) is also formed in the hub 150 so that the flow of air formed by the impeller 11 can be transmitted to the coil.

Hereinafter, the principle of blocking foreign substances according to the shape and structure of the sleeve 131 and the hub 150 and the dynamic pressure forming process of the fluid by using the fluid dynamic pressure groove formed in the shaft 120 and the sleeve 131 will be described in detail with reference to FIGS. 4 and 5.

Referring to FIGS. 4 and 5, the bearing device 100 according to an embodiment of the present invention prevents foreign substances such as dust from entering the lubricating fluid LF filled between the sleeve 131 and the shaft 120, and in order to form a dynamic pressure in the lubricating fluid LF, the sleeve 131 includes the configuration of a sealing accommodating groove 132, a sleeve tapered portion 133, a bearing accommodating groove 134, and a first radial dynamic pressure groove 135, and a second radial dynamic pressure groove 136, and the hub 150 includes the configuration of a sleeve upper cover body 151 and a sealing protrusion 152.

The sealing accommodating groove 132 is formed as a groove having a retracted structure corresponding to the shape of the sealing protrusion 152 in order to accommodate the sealing protrusion 152 of the hub 150 to be described later and extends along the circumferential direction on the upper surface of the sleeve 131.

In this case, the sealing accommodating groove 132 may be formed at any position (radius) of the upper surface of the sleeve 131, but is preferably formed along the outermost diameter, that is, the outer edge of the sleeve 131. Here, the sealing accommodating groove 132 is not only formed on the outer edge of the sleeve 131, but also formed in plurality for each radius of the sleeve 131 on the upper surface of the sleeve 131, and the sealing protrusion 152 is also formed in plurality to protrude and corresponds to or is inserted into its structure so that the gap between the upper surface of the sleeve 131 and the sleeve upper cover body 151 is refracted and extended to prevent external leakage of the lubricating fluid LF, as well as further suppress the entry of external foreign substances.

However, the sealing accommodating groove 132 is only formed on the outer edge of the sleeve 131 so that the above-described effects can be achieved. Specifically, the sleeve upper cover body 151 of the present invention has a structure that is inserted into the shaft coupling tube 112 as described above, and is already a leakage path of the lubricating fluid LF just by being inserted and deepening the depth, and it is possible to extend the entry path of foreign substances, as well as greatly refract the path may be refracted and thus the above-described leakage and entry may be difficult.

Also, in the sleeve upper cover body 151 of the hub 150, a lower surface adjacent to the shaft 120 among the lower surfaces of the hub 150 is formed to protrude downward to cover the upper portion of the shaft coupling tube 112, so that the sleeve 131 is not exposed to the outside. At this time, the outer radius of the sleeve upper cover body 151 corresponds to the inner radius of the shaft coupling pipe 112 or is formed narrower than that, so that the sleeve upper cover body 151 is inserted into the shaft coupling tube 112 and it is preferable to cover the upper portion of the shaft coupling tube 112.

The sealing protrusion 152 of the hub 150 protrudes from the sleeve upper cover body 151 and is formed to correspond to the shape and structure of the above-described sealing accommodating groove 132 or is formed to be inserted thereinto and thus rotates along the sealing accommodating groove 132 in a state in which the sealing protrusion 152 of the hub 150 is accommodated in the sealing accommodating groove 132 described above. At this time, the sealing protrusion 152 blocks and covers the gap between the sleeve 131 and the sleeve upper cover body 151 formed in the horizontal direction, thereby blocking the gap from being exposed to the outside. As a result, the lubricating fluid LF used in the present invention is filled in the bearing by vacuum suction in a state in which the shaft 120 is supported by the sleeve 131 and the thrust bearing 137 by the coupling between the sleeve 131 and the sleeve lower cover body 138, and then, when the hub 151 is assembled on the open sleeve 131, as described above, the sleeve upper cover body 151 covers the upper portion of the sleeve 131, that is, the lubricating fluid LF filled between the shaft 120 and the inner circumferential surface of the sleeve 131, and the sealing protrusion 152 again blocks and covers the gap between the sleeve upper cover body 151 and the upper surface of the sleeve 131, so that foreign substances can be prevented from entering the filled lubricating fluid LF.

As a result, the subsequent assembly process of the shaft 120 and the shaft coupling tube 112 enables assembly without the entry of foreign substances such as dust even in a non-clean room environment, so that cost and time required for the assembly process of the shaft 120 and the shaft coupling tube 112 assembled in the existing clean room environment can be greatly reduced.

On the other hand, a shaft tapered portion 122 having a structure in which the radius of the shaft 120 becomes narrower toward the upper portion of the shaft 120, is provided in a portion of the upper portion of the shaft 120 facing or adjacent to the upper portion of the sleeve 131 to be described later. This tapered structure is for suppressing the flow of the lubricating fluid LF filled between the shaft 120 and the sleeve 131 to escape or scatter to the outside by the rotation of the shaft 120. A pressure gradient is formed by a difference in the gap in the tapered portion so that the lubricating fluid LF between the shaft 120 and the sleeve 131 is directed to the inside, that is, the gap formed between the shaft 120 and the sleeve 131.

In addition, a sleeve tapered portion 133 corresponding to the above-described shaft tapered portion 122 is formed on an inner edge of the upper surface of the sleeve 131, so that a gap between the outer circumferential surface of the shaft 120 and the inner circumferential surface of the sleeve 131 is increased toward the upper portion of the shaft 120 and thus external escape or scattering of the lubricating fluid LF by the rotation of the shaft 120 can be suppressed. At this time, either one of the shaft tapered portion 122 and the sleeve tapered portion 133 may be formed or both may be formed.

The bearing accommodating groove 134 is for coupling with the thrust bearing 137, and the inner circumferential surface of the lower surface of the sleeve 131 is retracted inward or upward.

In addition, a first radial dynamic pressure groove 135 and a second radial dynamic pressure groove 136 are formed on the inner and outer circumferential surfaces of the sleeve 131, respectively, a dynamic pressure of the lubricating fluid LF may be formed between the sleeve 131 and the shaft 120 or between the sleeve 131 and the shaft coupling tubes 112. Specifically, a first radial groove is formed in the inner circumferential surface of the sleeve 131 to have a structure that is retracted along the longitudinal and circumferential directions of the inner circumferential surface of the sleeve 131 to accommodate the fluid, and thus the dynamic pressure of the fluid is formed by the rotation of the shaft 120, and a second radial groove is formed in the outer circumferential surface of the sleeve 131 to have a structure that is retracted along the circumferential direction of the outer circumferential surface of the sleeve 131, and is formed in plurality at regular intervals along the longitudinal direction so that the dynamic pressure of the fluid is formed by the rotation of the shaft 120. At this time, the first radial groove is preferably formed in the central portion of the shaft 120 surrounded around the sleeve 131, and because the pressure of the fluid by the rotation of the shaft 120 is relatively less than a portion close to the shaft 120, the second radial groove is preferably formed in the lower portion of the sleeve 131 surrounded around the shaft coupling tube 112. In addition, because it is advantageous for the second radial groove to be formed in a semicircular shape in a cross-section to form a dynamic pressure of the fluid, it is preferable to form a plurality of second radial grooves in a semicircular shape.

In addition, a thrust dynamic pressure groove 121 is also formed on the bottom surface of the shaft 120 so that the lubricating fluid LF filled in the gap between the shaft 120 and the sleeve lower cover body 138 forms a fluid dynamic pressure and the shaft 120 is rotatably supported.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bearing device comprising:
a holder comprising a base plate extending in a horizontal direction and a shaft coupling tube having a tube structure extending upward from a center of the base plate;
a shaft rotatably fitted to the shaft coupling tube;
a bearing module inserted between the shaft and the shaft coupling tube to rotatably support the shaft from the shaft coupling tube;
a housing fitted to or integrated with a lower portion of the shaft coupling tube to support the shaft in an axial direction; and
a hub coupled to the shaft to rotate together with the shaft and extending in a radial direction of the shaft to cover an upper portion of the shaft coupling tube into which the shaft is fitted,
wherein the bearing module comprises:
a sleeve that is inserted into the shaft in a state in which a gap between the sleeve and the shaft is filled with a lubricating fluid, and disposed between the shaft and the shaft coupling tube, thereby rotatably supporting an outer circumferential surface of the shaft from an inner circumferential surface of the shaft coupling tube, the sleeve including a sealing accommodating groove formed at an upper surface of the sleeve and having a retracted structure extending along a circumferential direction; and
a thrust bearing disposed between the sleeve and the housing to axially support a lower portion of the sleeve from the housing, and
the hub comprises:
a sleeve upper cover body protruding from a lower surface of the hub and facing an upper portion of the shaft coupling tube to cover an upper portion of the sleeve; and
a sealing protrusion protruding from the sleeve upper cover body and fitted into the sealing accommodating groove, thereby covering a gap formed between the sleeve upper cover body and the upper surface of the sleeve to prevent foreign substances from entering through the gap from an outside of the shaft coupling tube.

2. The bearing device of claim 1, wherein the sealing accommodating groove of the sleeve extends along an outer edge of the sleeve so that the sealing protrusion is installed to cover an outer circumferential surface of the sleeve.

3. The bearing device of claim 1, wherein the hub covers an upper portion of the sleeve so that an outer diameter of the sleeve upper cover body including the sealing protrusion is formed to be smaller than or equal to an inner diameter of the shaft coupling tube and thus the sleeve upper cover body is inserted into the shaft coupling tube to cover the upper part of the sleeve.

4. The bearing device of claim 1, wherein the lubricating fluid is filled in the bearing by vacuum suction in a state in which the shaft is supported by the sleeve and the thrust bearing and then, the shaft coupling tube is covered by the hub and the housing.

5. The bearing device of claim 1, wherein the inner circumferential surface of the upper surface of the sleeve or the outer circumferential surface of the shaft at a portion facing the inner circumferential surface of the upper surface of the sleeve is formed in a tapered structure that is retracted respectively or together along an upward direction of the shaft so that a gap between the inner circumferential surface of an upper portion of the sleeve and the outer circumferential surface of the shaft facing the inner circumferential surface of the upper portion of the sleeve is widened along the upward direction of the shaft.

6. The bearing device of claim 1, wherein the sleeve comprises a first radial dynamic pressure groove that is formed on an inner circumferential surface of the sleeve to be retracted along a circumferential direction so as to generate a dynamic pressure with the shaft by the lubricating fluid.

7. The bearing device of claim 6, wherein the sleeve further comprises a second radial dynamic pressure groove that extends in a semicircular retracted structure along a circumferential direction on a lower outer circumferential surface and is formed in a plurality at regular intervals along an axial direction to generate a dynamic pressure with the shaft coupling tube by using the lubricating fluid.

8. The bearing device of claim 1, further comprising a sleeve lower cover body that is disposed on a lower surface of the shaft, a lower surface of the thrust bearing, and a lower surface of the sleeve to support the shaft, the thrust bearing, and the sleeve in an axial direction of the shaft.

9. The bearing device of claim 8, wherein the shaft comprises a thrust dynamic pressure groove formed in a semicircular retracted structure on a lower surface of the shaft so as to generate a dynamic pressure with the sleeve lower cover body by the lubricating fluid.

10. A motor comprising:
a holder comprising a base plate extending in a horizontal direction and a shaft coupling tube having a tube structure extending upward from a center of the base plate;
a shaft rotatably fitted to the shaft coupling tube;
a bearing module inserted between the shaft and the shaft coupling tube to rotatably support the shaft from the shaft coupling tube;
a housing fitted to or integrated with a lower portion of the shaft coupling tube to support the shaft in an axial direction; and
a hub coupled to the shaft to rotate together with the shaft and extending in a radial direction of the shaft to cover an upper portion of the shaft coupling tube into which the shaft is fitted,
wherein the bearing module comprises:
a sleeve that is inserted into the shaft in a state in which a gap between the sleeve and the shaft is filled with a lubricating fluid, and disposed between the shaft and the shaft coupling tube, thereby rotatably supporting an outer circumferential surface of the shaft from an inner circumferential surface of the shaft coupling tube, the sleeve including a sealing accommodating groove formed at an upper surface of the sleeve and having a retracted structure extending along a circumferential direction; and
a thrust bearing disposed between the sleeve and the housing to axially support a lower portion of the sleeve from the housing, and
the hub comprises:
a sleeve upper cover body protruding from a lower surface of the hub and facing an upper portion of the shaft coupling tube to cover an upper portion of the sleeve;
a sealing protrusion protruding from the sleeve upper cover body and fitted into the sealing accommodating groove, thereby covering a gap formed between the sleeve upper cover body and the upper surface of the sleeve to prevent foreign substances from entering through the gap from an outside of the shaft coupling tube;
a stator fitted to an outside of the shaft coupling tube and fixed to the holder, the stator including a plurality of cores disposed on an outer edge of the holder; and
a rotor that is coupled to the hub and disposed to surround the stator and includes a plurality of magnets disposed to correspond to the cores on an inner circumferential surface facing an outer edge of the stator, and the rotor rotating along the outer edge of the stator by using a rotating magnetic field formed by the cores and the magnets by an alternating current applied to the cores, so that a rotational force is provided to the shaft.

11. A fan motor comprising:
a holder comprising a base plate extending in a horizontal direction and a shaft coupling tube having a tube structure extending upward from a center of the base plate;
a shaft rotatably fitted to the shaft coupling tube;
a bearing module inserted between the shaft and the shaft coupling tube to rotatably support the shaft from the shaft coupling tube;
a housing fitted to or integrated with a lower portion of the shaft coupling tube to support the shaft in an axial direction; and
a hub coupled to the shaft to rotate together with the shaft and extending in a radial direction of the shaft to cover an upper portion of the shaft coupling tube into which the shaft is fitted,
wherein the bearing module comprises:
a sleeve that is inserted into the shaft in a state in which a gap between the sleeve and the shaft is filled with a lubricating fluid, and disposed between the shaft and the shaft coupling tube, thereby rotatably supporting an outer circumferential surface of the shaft from an inner circumferential surface of the shaft coupling tube, the sleeve including a sealing accommodating groove formed at an upper surface of the sleeve and having a retracted structure extending along a circumferential direction; and
a thrust bearing disposed between the sleeve and the housing to axially support a lower portion of the sleeve from the housing, and
the hub comprises:
a sleeve upper cover body protruding from a lower surface of the hub and facing an upper portion of the shaft coupling tube to cover an upper portion of the sleeve;
a sealing protrusion protruding from the sleeve upper cover body and fitted into the sealing accommodating groove, thereby covering a gap formed between the sleeve upper cover body and the upper surface of the sleeve to prevent foreign substances from entering through the gap from an outside of the shaft coupling tube;
a stator fitted to an outside of the shaft coupling tube and fixed to the holder, the stator including a plurality of cores disposed on an outer edge of the holder;
a rotor that is coupled to the hub and disposed to surround the stator and includes a plurality of magnets disposed to correspond to the cores on an inner circumferential surface facing an outer edge of the stator, and the rotor rotating along the outer edge of the stator by using a rotating magnetic field formed by the cores and the magnets by an alternating current applied to the cores, so that a rotational force is provided to the shaft; and
an impeller coupled to the hub or the shaft and rotating so as to generate a flow of air.
